(19) United States
(12) Patent Application Publication
(10) Pub. No.: US 2026/0274079 A1
(43) Pub. Date: Sep. 17, 2026

(54) APPARATUS AND METHOD FOR MANAGING ELECTRIC VEHICLE BATTERY

(71) Applicants: Hyundai Motor Company, Seoul (KR); Kia Corporation, Seoul (KR)

(72) Inventors: YUNJEONG NAM, Hwaseong-Si (KR); Jiyeong SEO, Hwaseong-Si (KR); Donggil HA, Hwaseong-Si (KR); Min-gyu PARK, Hwaseong-Si (KR)

(21) Appl. No.: 19/280,394

(22) Filed: Jul. 25, 2025

(30) Foreign Application Priority Data
Mar. 11, 2025 (KR) 10-2025-0031060

(51) Int. Cl. B60L 7/18; B60L 58/12

(52) U.S. Cl. CPC B60L 7/18; B60L 58/12; B60L 2240/545

(57) ABSTRACT

An apparatus of a vehicle may comprise a processor and a memory storing at least one instruction. When executed by the processor communicating with the memory, the instruction is configured to cause the apparatus to detect, based on a measurement of a sensor of the vehicle, a state of change (SOC) of a battery pack of the vehicle. Based on the detected SOC of the battery pack falling within a regenerative braking restriction SOC region, the apparatus is further configured to control operation of the vehicle by disabling a regenerative braking of the vehicle.

### CROSS-REFERENCE TO RELATED APPLICATION

This present application claims the benefit of priority to Korean Patent Application No. 10-2025-0031060, filed on Mar. 11, 2025, in the Korean Intellectual Property Office, the entire disclosure of which is incorporated herein by reference.

### TECHNICAL FIELD

The present disclosure relates to an apparatus and method for managing an electric vehicle battery, and more specifically, to an apparatus and method for managing a battery of an electric vehicle that uses regenerative braking technology.

### BACKGROUND

Lithium-ion batteries are components as energy storage devices for electric vehicles, based on the principle of storing and releasing energy through charging and discharging processes. These batteries may use transition metal oxides as positive electrode materials and carbon as negative electrode materials. During charging and discharging, lithium ions move between the positive electrode and the negative electrode, and in this process, the positive and negative electrode materials undergo volume changes due to changes in crystal structure, which generates mechanical stress. Over time, this repeated charging and discharging degrades the structural stability of the electrode materials, leading to battery deterioration, which may serve as a factor in reducing battery durability.

Regenerative braking technology may operate without restrictions across the entire battery voltage range without considering phase transition zones, which are a cause of accelerated degradation of battery. The current generated during regenerative braking continuously applies stress to the electrode materials, potentially accelerating battery degradation.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

According to the present disclosure, an apparatus of a vehicle, the apparatus may comprise, a processor, and a memory storing at least one instruction that, when executed by the processor communicating with the memory, is configured to cause the apparatus to, detect, based on a measurement of a sensor of the vehicle, a state of change (SOC) of a battery pack of the vehicle, and based on the detected SOC of the battery pack falling within a regenerative braking restriction SOC region, control operation of the vehicle by disabling a regenerative braking of the vehicle.

The apparatus, wherein the at least one instruction, when executed by the processor communicating with the memory, is configured to cause the apparatus to, measure, via a temperature sensor of the vehicle, a temperature of the battery pack, adjust, based on the measured temperature of the battery pack, the regenerative braking restriction SOC region.

The apparatus, wherein the regenerative braking restriction SOC region is determined based on, a voltage corresponding to at least one peak identified in a differential capacity curve with respect to voltage, and characteristics of at least one of a battery cell, a module may comprise a plurality of battery cells, or the battery pack.

The apparatus, wherein a range of the regenerative braking restriction SOC region is determined based on a shape of the at least one peak.

The apparatus, wherein a peak with an amplitude lower than a preset value among the at least one peak is excluded from the determination of the regenerative braking restriction SOC region.

The apparatus, wherein the at least one instruction, when executed by the processor communicating with the memory, is configured to cause the apparatus to stop regenerative braking based on the SOC of the battery pack entering the regenerative braking restriction SOC region as a result of regenerative braking.

The apparatus, wherein the regenerative braking restriction SOC region corresponds to a zone where a phase transition occurs in the battery pack.

The apparatus, wherein the at least one instruction, when executed by the processor communicating with the memory, is configured to cause the apparatus to determine the regenerative braking restriction SOC region based on battery information including the SOC of the battery pack.

According to the present disclosure, a method performed by an apparatus of a vehicle, the method may comprise, detecting, based on a measurement of a sensor of the vehicle, a state of charge (SOC) of a battery pack of the vehicle, determining whether the detected SOC of the battery pack falls within a regenerative braking restriction SOC region, and based on the SOC of the battery pack falling within the regenerative braking restriction SOC region, controlling operation of the vehicle by disabling a regenerative braking of the vehicle.

The method may further comprise, before the determining of whether the SOC of the battery pack falls within the regenerative braking restriction SOC region, measuring, via a temperature sensor of the vehicle, a temperature of the battery pack, adjusting, based on the measured temperature of the battery pack, the regenerative braking restriction SOC region.

The method, wherein the regenerative braking restriction SOC region is determined based on, a voltage corresponding to at least one peak identified in a differential capacity curve with respect to voltage, characteristics of at least one of a battery cell, a module may comprise a plurality of battery cells, or the battery pack.

The method, wherein a range of the regenerative braking restriction SOC region is determined based on a shape of the at least one peak.

The method, wherein a peak with an amplitude lower than a preset value among the at least one peak is excluded from the determination of the regenerative braking restriction SOC region.

The method, wherein the controlling of operation of the vehicle may comprise stopping regenerative braking based on the SOC of the battery pack entering the regenerative braking restriction SOC region as a result of regenerative braking.

The method, wherein the regenerative braking restriction SOC region corresponds to a zone where a phase transition occurs in the battery pack.

The method may further comprise, after the detecting of the SOC of the battery pack, determining the regenerative braking restriction SOC region based on battery information including the SOC of the battery pack.

According to the present disclosure, a vehicle may comprise, a battery, at least one sensor associated with the battery, a motor, a motor control circuit configured to transmit a driving control signal to control the motor and control a driving operation of the vehicle, a processor, and a memory storing at least one instruction that, when executed by the processor communicating with the memory, is configured to cause the vehicle to, while controlling the driving operation of the vehicle travelling on a road, detecting, based on a measurement of the at least one sensor, a state of charge (SOC) of the battery, determining whether the SOC falls within an SOC range corresponding to a regenerative braking restriction region, and based on the SOC entering the SOC range corresponding to the regenerative braking restriction region, controlling the driving operation of the vehicle by disabling a regenerative braking of the vehicle or stopping a regenerative braking operation of the vehicle.

The vehicle, wherein the SOC range is set based on a phase transition characteristic associated with the battery and based on a temperature of the battery, and wherein the at least one instruction, when executed by the processor communicating with the memory, is configured to cause the vehicle to, determine, based on a voltage and a capacity of the battery during charging or discharging of the battery, the phase transition characteristic.

The vehicle, wherein the phase transition characteristic is associated with a phase transition zone of an electrode material of the battery, and wherein the phase transition zone corresponds to a voltage range that causes accelerated degradation of the battery.

The vehicle, wherein the determining of whether the SOC falls within the SOC range corresponding to the regenerative braking restriction region may comprise excluding a peak identified in a differential capacity curve from use in defining the regenerative braking restriction region based on an amplitude of the peak being below a preset threshold.

### BRIEF DESCRIPTION OF THE DRAWINGS

The foregoing and other examples, as well as the following detailed description of the examples, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 shows an exemplary configuration diagram of an apparatus for managing an electric vehicle battery according to one example of the present disclosure.

FIG. 2 shows an example of a method for managing an electric vehicle battery according to one example of the present disclosure.

FIG. 3 shows an exemplary diagram of a dQ/dV chart for battery voltage according to one example of the present disclosure.

FIG. 4 shows an example of regenerative braking restriction SOC regions according to one example of the present disclosure.

FIG. 5 shows an example of regenerative braking control during driving according to one example of the present disclosure.

FIG. 6 shows an exemplary diagram of an effect of regenerative braking restriction during driving according to one example of the present disclosure.

FIG. 7 shows an example computing system (e.g., a computing device of a vehicle or any other apparatus).

### DETAILED DESCRIPTION

Examples disclosed in the present specification will be described in greater detail with reference to the accompanying drawings, and throughout the accompanying drawings, the same reference numerals are used to designate the same or similar components and redundant descriptions thereof are omitted. As used herein, the terms “module” and “unit” used to refer to components are used interchangeably in consideration of convenience of explanation, and thus, the terms per se should not be considered as having different meanings or functions. In relation to describing the present disclosure, when the detailed description of the relevant known technology is determined to unnecessarily obscure the gist of the present disclosure, the detailed description may be omitted. Furthermore, it should be understood that the appended drawings are intended only to help understand examples disclosed in the present document and do not limit the technical principles and scope of the present disclosure. Rather, it should be understood that the appended drawings include all of the modifications, equivalents or substitutes described by the technical principles and belonging to the technical scope of the present disclosure.

Although the terms first, second, third, and the like may be used herein to describe various elements, components, regions, layers, and/or sections, these elements, components, regions, layers, and/or sections should not be limited by these terms. These terms are only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B

When a component, unit, device, element, apparatus, or the like of the present disclosure is described as having a purpose or performing an operation, function, or the like, the component, unit, device, element, apparatus, or the like should be considered herein as being “configured to” meet that purpose or to perform that operation or function. Each component, unit, device, element, apparatus, and the like may separately embody or be included with a processor and a memory, such as a non-transitory computer readable media, as part of the apparatus.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of managing a battery of a vehicle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of managing a battery of a vehicle) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of managing a battery of a vehicle) described herein.

Minimum risk maneuver (MRM) operation(s) may also be controlled, for example, based on one or more features (e.g., feature of managing a battery of a vehicle) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of managing a battery of a vehicle) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of managing a battery of a vehicle) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., feature of managing a battery of a vehicle) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

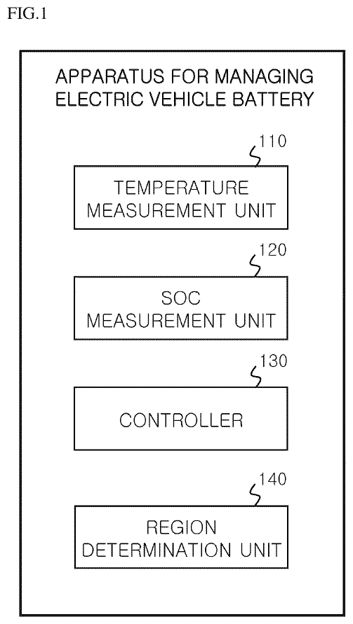

Hereinafter, an electric vehicle battery management apparatus and method according to the present disclosure will be described in detail with reference to FIGS. 1 to 6.

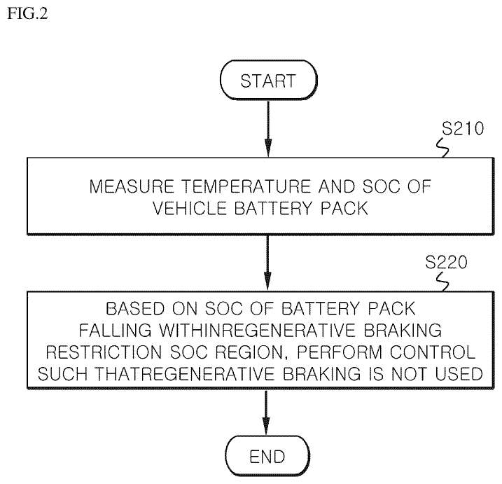

FIG. 1 shows an exemplary configuration diagram of an electric vehicle battery management apparatus according to one example of the present disclosure, and FIG. 2 shows an example of an electric vehicle battery management method according to one example of the present disclosure.

Referring to FIG. 1, an apparatus for managing an electric vehicle battery (100) according to one example of the present disclosure may include a temperature measurement unit (110), a SOC measurement unit (120), a controller (130), a region determination unit (140), or other related components (e.g., memory, communication interface, or diagnostic circuitry, etc.).

The temperature measurement unit (110) may measure the temperature of the battery pack (see step S210 in FIG. 2).

For example, the temperature measurement unit (110) may include a sensor designed to measure temperature by contacting the battery cell, module, or pack, or in a non-contact manner within a certain distance (e.g., via infrared sensing, laser thermometry, ultrasonic methods, or thermal imaging, etc.). The sensor may be implemented in various forms such as a semiconductor-based temperature sensors, a thermocouple, an infrared temperature sensor, a thermistor, or a resistance temperature detector (RTD), etc.

The SOC measurement unit (120) may measure the SOC of the battery pack (see step S210 in FIG. 2).

For example, the SOC measurement unit (120) may include a sensor designed to measure the charge state of battery cells, modules (e.g., each module comprising a plurality of battery cells), or battery packs in real time (e.g., using voltage-based estimation, Coulomb counting, impedance spectroscopy, or sensor fusion algorithms, etc.). The sensor may be implemented in various forms such as a voltage sensor, a current sensor, an impedance sensor, a Coulomb counter, or a Kalman filter-based estimator, etc., and may determine the SOC by detecting changes according to charging and discharging states of the battery.

Meanwhile, the controller (130) may perform control such that regenerative braking is not used if the SOC of the battery pack falls within a regenerative braking restriction SOC region, the region being determined based on the temperature and the SOC of the battery pack (e.g., derived from pre-characterized phase transition zones, safety thresholds, or performance degradation profiles, etc.) (see step S220 in FIG. 2).

The regenerative braking restriction SOC region may be derived preferably using an incremental capacity analysis (ICA) method for at least one of the cell, the module, or the pack constituting the battery pack under various temperature conditions. Specifically, by identifying peaks of dQ/dV according to voltage, phase transition zones at different temperatures of the battery cells, modules, or packs may be identified, and these may be used as regenerative braking restriction SOC regions.

For example, charging and discharging tests may be conducted on cells to be included in electric vehicle batteries under various temperature conditions, and after measuring cell voltage (V) and capacity (Q), incremental capacity analysis may be applied to obtain dQ/dV curves (e.g., differential capacity curve), thereby identifying peaks, which are points of rapid change (e.g., associated with phase transitions, SEI formation, or structural shifts in electrode material, etc.).

After measuring the overall voltage and capacity of modules composed of a plurality of cells while charging and discharging at a constant current or under actual vehicle operation (e.g., driving conditions), these measurements may be analyzed under various temperature conditions using the incremental capacity analysis method to obtain dQ/dV curves (e.g., differential capacity curve for detecting phase transitions, capacity fade, lithium plating, or electrode imbalance, etc.). Here, since the phase transition characteristics of individual cells within the module are comprehensively reflected, peaks that were not observed in cell-level analysis may newly emerge, or conversely, peaks that were strongly present only in some cells may be diminished or offset.

Furthermore, dQ/dV curves (e.g., differential capacity curve) may be obtained by measuring the voltage and capacity for an entire pack composed of a plurality of connected modules and performing incremental capacity analysis under various temperature conditions (e.g., cold start, ambient room temperature, elevated thermal states, or rapid charge/discharge cycles, etc.).

Curves based on the entire pack as a unit show combined mutual influences between modules (e.g., a module comprising a plurality of battery cells) and between cells (e.g., battery cells), so peaks found in module-level analysis may be weakened or appear in new forms (e.g., due to thermal gradients, cell imbalance, or wiring resistance effects, etc.).

The final regenerative braking restriction SOC region may be determined by analyzing electrical characteristics such as dQ/dV curves (e.g., differential capacity curve) derived from two or more of the cell, the module, or the battery pack (e.g., by identifying overlapping phase transition peaks, evaluating consistency across scales, or applying weighted averaging of critical SOC ranges, etc.). For example, strategies suitable for development goals may be selected, such as setting the regenerative braking restriction SOC region based on SOC ranges where peaks appear in both cell-level and pack-level analyses, or including SOC intervals in the regenerative braking restriction SOC region if significant peaks are identified in at least one of these two analysis levels (e.g., to ensure conservative protection, enhance calibration granularity, or accommodate production variances, etc.).

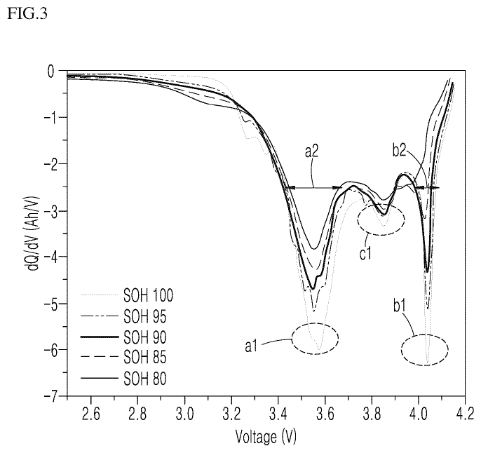

FIG. 3 shows an exemplary diagram of a dQ/dV chart for battery voltage according to one example of the present disclosure.

Referring to FIG. 3, a voltage-versus-dQ/dV chart derived from analyzing a battery's cell, module, or pack at a specific temperature is shown. By analyzing for various state of health (SoH) values, a more accurate phase transition zone may be derived. Here, two peaks, a1 and a2, may be identified (e.g., corresponding to phase changes in layered oxide materials or redox activity at distinct voltage plateaus, etc.).

The range of the regenerative braking restriction SOC region may be determined based on the shape of the peaks (e.g., peak height, width, slope, or relative prominence, etc.).

For example, after comprehensively reviewing the width, height, and symmetry of the peak, the regenerative braking restriction SOC region may be determined by setting a range of ±α based on the SOC at the center of the peak, or by expanding the SOC interval when the width is wide (e.g., to account for thermal broadening, material heterogeneity, or measurement uncertainty, etc.). Referring to FIG. 3, the regenerative braking restriction SOC region for the SOC a1 peak may preferably be determined as the width a2, and the regenerative braking restriction SOC region for the SOC a2 peak may preferably be determined as the width b2 (e.g., where α may be empirically tuned based on system-level stress tests or target life-cycle metrics, etc.).

Here, when there are multiple peaks, a peak with an amplitude lower than a preset value may be excluded when determining the regenerative braking restriction SOC region (e.g., to minimize false positives due to noise or secondary side reactions, etc.).

For example, if small peaks (e.g., a peak with an amplitude lower than a preset threshold value) formed due to measurement equipment errors, battery material characteristics, usage environment, or the like, are judged not to sufficiently reflect phase transition phenomena, such small peaks may be excluded from use in defining the regenerative braking restriction SOC region. Instead, more effective peaks may be selected using a preset value (e.g., a peak with an amplitude higher or equal to a preset amplitude threshold value, signal-to-noise ratio, or statistical confidence level, etc.) to determine or define the regenerative braking restriction SOC region. Referring to FIG. 3, c1 is also a peak, but because its amplitude is low, it may be judged not to be a peak that may be considered as a phase transition, and may be excluded when determining the regenerative braking restriction SOC region (e.g., based on predefined amplitude thresholds or comparison against reference data, etc.).

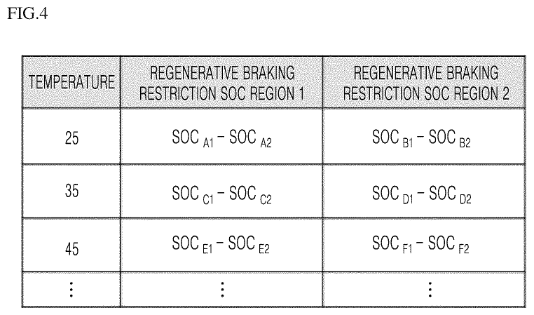

FIG. 4 shows an example of regenerative braking restriction SOC regions according to one example of the present disclosure.

Referring to FIG. 4, two regenerative braking restriction SOC regions are designated, and those regions may vary according to temperature (e.g., ambient conditions, battery internal temperature, coolant system status, or thermal aging effects, etc.). SOCₓ₁ may be the lower SOC limit of the regenerative braking restriction SOC region, and SOCₓ₂ may be the upper SOC limit of the regenerative braking restriction SOC region. For example, at 25° C. degrees, there is a regenerative braking restriction SOC region with SOC_{A1} as the lower SOC limit and SOC_{A2} as the upper SOC limit, and a second regenerative braking restriction SOC region with SOC_{B1} as the lower SOC limit and SOC_{B2} as the upper SOC limit (e.g., corresponding to distinct phase transitions at mid-range and high SOC levels, etc.). On the other hand, the regenerative braking restriction SOC region may not be distinguished according to temperature. In such case, a consistent regenerative braking restriction SOC region may be used regardless of the battery pack's temperature (e.g., to simplify control logic, reduce sensor dependency, or support legacy vehicle platforms, etc.). For example, the overlap between regenerative braking restriction SOC regions derived under various temperature conditions may be used as a single regenerative braking restriction SOC region, or alternatively, the regenerative braking restriction SOC region under room temperature conditions may be used as a single regenerative braking restriction SOC region (e.g., for system simplicity, memory efficiency, or to avoid temperature-sensor calibration drift, etc.).

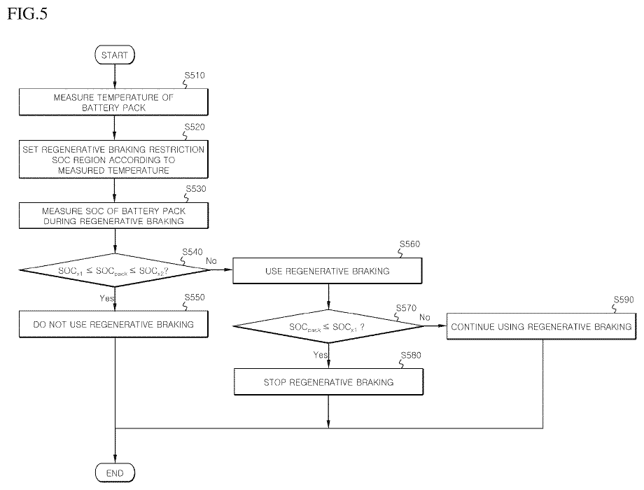

FIG. 5 shows an example of regenerative braking control during driving according to one example of the present disclosure.

Referring to FIG. 5, the controller (130) may set the regenerative braking restriction SOC region corresponding to the temperature (see step S510 in FIG. 5) of the electric vehicle's battery pack measured by the temperature measurement unit (110) (see step S520 in FIG. 5) (e.g., based on temperature-dependent phase transition thresholds or thermal stress zones, etc.). During vehicle driving where regenerative braking is used, the controller (130) may receive SOC information from the battery pack via the SOC measurement unit (see step S530 in FIG. 5). Based on the SOC of the battery pack falling within the regenerative braking restriction SOC region (see step S540 in FIG. 5), the controller (130) may perform control such that regenerative braking is not used (see S550 in FIG. 5), and based on the SOC falling outside the regenerative braking restriction SOC region, regenerative braking may be used (see step S560 in FIG. 5) (e.g., to maximize energy recovery during optimal SOC ranges, such as mid-level charge conditions, etc.). If regenerative braking occurs and the SOC enters the regenerative braking restriction SOC region (see step S570 in FIG. 5), the controller (130) may stop the regenerative braking to prevent further charging and mitigate degradation-related stress so as to prevent the SOC of the battery pack from rising (see step S580 in FIG. 5) (e.g., during low-speed braking, extended downhill driving, or traffic deceleration events, etc.). If regenerative braking occurs but the battery does not enter the regenerative braking restriction SOC region, regenerative braking may continue to be used (see step S590 in FIG. 5) (e.g., during downhill driving, energy recovery braking, or low-speed deceleration, etc.).

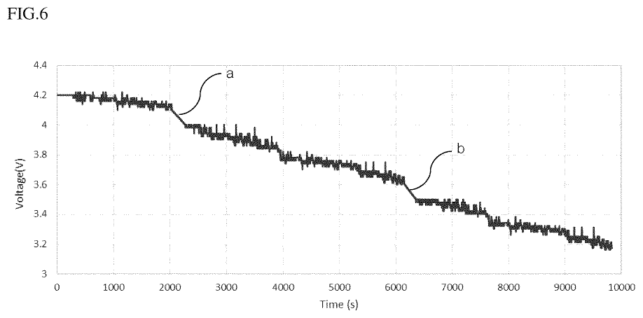

FIG. 6 shows an exemplary diagram of an effect of regenerative braking restriction during driving according to one example of the present disclosure.

Referring to FIG. 6, at a and b, it may be seen that the electric vehicle battery's voltage drops consistently because regenerative braking is not occurring if the SOC enters the regenerative braking restriction SOC region (e.g., at SOC levels associated with phase transition stress or thermal instability, etc.).

Meanwhile, a region determination unit (140) may be further included to determine the regenerative braking restriction SOC region based on battery information including the SOC and temperature of the battery pack (e.g., retrieved from internal sensors, historical datasets, or cloud-connected analytics, etc.).

For example, the region determination unit (140) may comprehensively consider various data such as the battery pack's SoH, past driving history, charging and discharging patterns, external environment, and the like, in addition to the battery pack's temperature and SOC information periodically received from the temperature measurement unit (110) and SOC measurement unit (120) (e.g., daily commute length, seasonal temperature trends, regenerative braking frequency, or battery aging indicators, etc.). The region determination unit (140) may set the regenerative braking restriction SOC region based on the phase transition characteristics and temperature dependence identified through dQ/dV curve analysis, or dynamically modify already set restriction SOC regions according to changes in driving environment (e.g., aggressive acceleration, frequent start-stop traffic, ambient cold-weather conditions, or high-load operation, etc.). Here, the region determination unit (140) may additionally apply correction logic for driving conditions and driving patterns, enabling the controller (130) to appropriately restrict or adjust regenerative braking based on entry into dangerous zones, thereby increasing driver satisfaction (e.g., by maintaining smooth deceleration, preventing overcharging, or optimizing energy recovery, etc.).

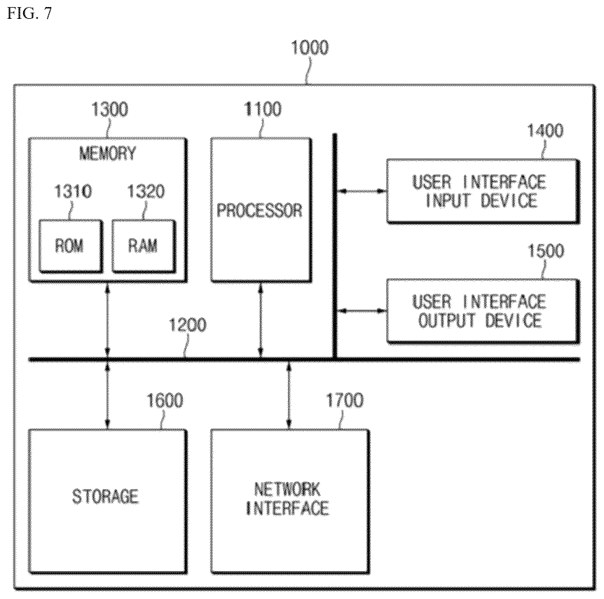

FIG. 7 shows an example computing system (e.g., a computing device of a vehicle or any other apparatus). One or more controllers, processors, etc. described herein, such as one or more components of the vehicle and any other components and devices disclosed herein, may be implemented by or in the computing system as shown in FIG. 7.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The present disclosure is directed to providing an apparatus and method for managing an electric vehicle battery that is capable of identifying phase transition zones affecting battery degradation (e.g., accelerated degradation) during regenerative braking and inhibiting regenerative braking in those zones, to reduce degradation occurring during battery charging and discharging processes, thereby improving battery durability.

The present disclosure is further directed to providing an apparatus and method for managing electric vehicle batteries that is capable of identifying phase transition zones according to battery temperature and, based on the identified zones, efficiently managing regenerative braking to improve the durability of the electric vehicle battery.

The present disclosure is further directed to providing an apparatus and method for managing electric vehicle batteries capable of alleviating mechanical stress applied to battery electrode materials during regenerative braking to maintain structural stability, and thereby improve the long-term reliability and energy efficiency of the electric vehicle.

Examples of the present disclosure are not limited to those mentioned above, and other examples and advantages not mentioned above will be understood from the following description, and become more apparent from the examples. Moreover, examples of the present disclosure may be realized by the means and combinations thereof indicated in claims.

An apparatus for managing an electric vehicle battery according to one example of the present disclosure may include a state of charge (SOC) measurement unit configured to measure a SOC of a battery pack, and a controller configured to, based on the measured SOC of the battery pack falling within a regenerative braking restriction SOC region, perform control such that regenerative braking is not used.

The apparatus may further include a temperature measurement unit configured to measure a temperature of the battery pack, and the controller may be configured to set the regenerative braking restriction SOC region differently according to the temperature of the battery pack.

The regenerative braking restriction SOC region may be determined based on a voltage at which a peak of dQ/dV with respect to voltage is observed, based on an analysis of at least one of a cell, a module, or a pack constituting the battery pack.

A method for managing an electric vehicle battery according to another example of the present disclosure may include measuring a state of charge (SOC) of a battery pack, determining whether the SOC of the battery pack falls within a regenerative braking restriction SOC region based on the SOC of the battery pack, and based on the SOC of the battery pack falling within the regenerative braking restriction SOC region, performing control such that regenerative braking is not used.

The method may further include, before the determining, measuring a temperature of the battery pack, and the performing control may include setting the regenerative braking restriction SOC region differently according to the temperature of the battery pack.

The regenerative braking restriction SOC region may be determined based on a voltage at which a peak of dQ/dV with respect to voltage is observed, based on an analysis of at least one of a cell, a module, or a pack constituting the battery pack.

According to examples of the present disclosure, degradation occurring during battery charging and discharging processes may be reduced by identifying phase transition zones that affect battery degradation during regenerative braking and inhibiting regenerative braking in those zones, thereby improving battery durability.

Furthermore, according to examples of the present disclosure, the durability of the electric vehicle battery may be improved by identifying phase transition zones according to battery temperature and efficiently managing regenerative braking accordingly.

Furthermore, according to examples of the present disclosure, mechanical stress applied to battery electrode materials during regenerative braking may be alleviated to maintain structural stability, thereby improving the long-term reliability and energy efficiency of the electric vehicle.

As used in the present disclosure (especially in the appended claims), the terms “a/an” and “the” include both singular and plural referents, unless the context clearly states otherwise. Also, it should be understood that any numerical range recited in the present disclosure is intended to include all sub-ranges subsumed therein (unless expressly indicated otherwise) and accordingly, the disclosed numeral ranges include every individual value between the minimum and maximum values of the numeral ranges.

The steps constituting the method according to the present disclosure may be performed in an appropriate order unless a specific order is described or otherwise specified. That is, the present disclosure is not necessarily limited to the order in which the steps are recited. All examples described in the present disclosure or the terms indicative thereof (“for example”, “such as”) are merely to describe the present disclosure in greater detail. Therefore, it should be understood that the scope of the present disclosure is not limited to the example examples described above or by the use of such terms unless limited by the appended claims. Also, it should be apparent to those skilled in the art that various modifications, combinations, and alternations may be made depending on design conditions and factors within the scope of the appended claims or equivalents thereof.

The present disclosure is thus not limited to the example examples described above, and rather intended to include the following appended claims, and all modifications, equivalents, and alternatives falling within the spirit and scope of the following claims.

What is claimed:

1. An apparatus of a vehicle, the apparatus comprising:
a processor; and
a memory storing at least one instruction that, when executed by the processor communicating with the memory, is configured to cause the apparatus to:
detect, based on a measurement of a sensor of the vehicle, a state of change (SOC) of a battery pack of the vehicle, and
based on the detected SOC of the battery pack falling within a regenerative braking restriction SOC region, control operation of the vehicle by disabling a regenerative braking of the vehicle.

2. The apparatus of claim 1, wherein the at least one instruction, when executed by the processor communicating with the memory, is configured to cause the apparatus to:
measure, via a temperature sensor of the vehicle, a temperature of the battery pack,
adjust, based on the measured temperature of the battery pack, the regenerative braking restriction SOC region.

3. The apparatus of claim 1, wherein the regenerative braking restriction SOC region is determined based on:
a voltage corresponding to at least one peak identified in a differential capacity curve with respect to voltage, and
characteristics of at least one of a battery cell, a module comprising a plurality of battery cells, or the battery pack.

4. The apparatus of claim 3, wherein a range of the regenerative braking restriction SOC region is determined based on a shape of the at least one peak.

5. The apparatus of claim 3, wherein a peak with an amplitude lower than a preset value among the at least one peak is excluded from the determination of the regenerative braking restriction SOC region.

6. The apparatus of claim 1, wherein the at least one instruction, when executed by the processor communicating with the memory, is configured to cause the apparatus to stop regenerative braking based on the SOC of the battery pack entering the regenerative braking restriction SOC region as a result of regenerative braking.

7. The apparatus of claim 1, wherein the regenerative braking restriction SOC region corresponds to a zone where a phase transition occurs in the battery pack.

8. The apparatus of claim 1, wherein the at least one instruction, when executed by the processor communicating with the memory, is configured to cause the apparatus to determine the regenerative braking restriction SOC region based on battery information including the SOC of the battery pack.

9. A method performed by an apparatus of a vehicle, the method comprising:
detecting, based on a measurement of a sensor of the vehicle, a state of charge (SOC) of a battery pack of the vehicle;
determining whether the detected SOC of the battery pack falls within a regenerative braking restriction SOC region; and
based on the SOC of the battery pack falling within the regenerative braking restriction SOC region, controlling operation of the vehicle by disabling a regenerative braking of the vehicle.

10. The method of claim 9, further comprising:
before the determining of whether the SOC of the battery pack falls within the regenerative braking restriction SOC region, measuring, via a temperature sensor of the vehicle, a temperature of the battery pack,
adjusting, based on the measured temperature of the battery pack, the regenerative braking restriction SOC region.

11. The method of claim 9, wherein the regenerative braking restriction SOC region is determined based on:
a voltage corresponding to at least one peak identified in a differential capacity curve with respect to voltage,
characteristics of at least one of a battery cell, a module comprising a plurality of battery cells, or the battery pack.

12. The method of claim 11, wherein a range of the regenerative braking restriction SOC region is determined based on a shape of the at least one peak.

13. The method of claim 11, wherein a peak with an amplitude lower than a preset value among the at least one peak is excluded from the determination of the regenerative braking restriction SOC region.

14. The method of claim 9, wherein the controlling of operation of the vehicle comprises stopping regenerative braking based on the SOC of the battery pack entering the regenerative braking restriction SOC region as a result of regenerative braking.

15. The method of claim 9, wherein the regenerative braking restriction SOC region corresponds to a zone where a phase transition occurs in the battery pack.

16. The method of claim 9, further comprising, after the detecting of the SOC of the battery pack, determining the regenerative braking restriction SOC region based on battery information including the SOC of the battery pack.

17. A vehicle comprising:
a battery;
at least one sensor associated with the battery;
a motor;
a motor control circuit configured to transmit a driving control signal to control the motor and control a driving operation of the vehicle;
a processor; and
a memory storing at least one instruction that, when executed by the processor communicating with the memory, is configured to cause the vehicle to:
while controlling the driving operation of the vehicle travelling on a road, detecting, based on a measurement of the at least one sensor, a state of charge (SOC) of the battery;
determining whether the SOC falls within an SOC range corresponding to a regenerative braking restriction region; and
based on the SOC entering the SOC range corresponding to the regenerative braking restriction region, controlling the driving operation of the vehicle by disabling a regenerative braking of the vehicle or stopping a regenerative braking operation of the vehicle.

18. The vehicle of claim 17, wherein the SOC range is set based on a phase transition characteristic associated with the battery and based on a temperature of the battery, and
wherein the at least one instruction, when executed by the processor communicating with the memory, is configured to cause the vehicle to:
determine, based on a voltage and a capacity of the battery during charging or discharging of the battery, the phase transition characteristic.

19. The vehicle of claim 18, wherein the phase transition characteristic is associated with a phase transition zone of an electrode material of the battery, and wherein the phase transition zone corresponds to a voltage range that causes accelerated degradation of the battery.

20. The vehicle of claim 17, wherein the determining of whether the SOC falls within the SOC range corresponding to the regenerative braking restriction region comprises excluding a peak identified in a differential capacity curve from use in defining the regenerative braking restriction region based on an amplitude of the peak being below a preset threshold.
